(19) United States
(12) Patent Application Publication
(10) Pub. No.: US 2009/0312871 A1
(43) Pub. Date: Dec. 17, 2009

(54) SYSTEM AND METHOD FOR CALCULATING LOCATION USING A COMBINATION OF ODOMETRY AND LANDMARKS

(76) Inventors: Jae-Yeong Lee, Daejeon-city (KR); Heesung Chae, Daejeon-city (KR); Won-Pil Yu, Ulsan-city (KR)

Correspondence Address: STAAS & HALSEY LLP, SUITE 700, 1201 NEW YORK AVENUE, N.W., WASHINGTON, DC, 20005, US

(21) Appl. No.: 12/375,165

(22) PCT Filed: Mar. 13, 2007
(86) PCT No.: PCT/KR07/01201

§ 371 Date: Jan. 26, 2009

(30) Foreign Application Priority Data
Jul. 27, 2006 (KR) 10-2006-0070838

(51) Int. Cl. G06F 7/00

(52) U.S. Cl. 700/259; 901/1; 901/47

(57) ABSTRACT

Disclosed is a system and method for calculation a location in a real-time manner using a combination of odometry and artificial landmarks. The system for calculating a location comprising a landmark detection unit detecting an image coordinates value of the artificial landmark corresponding to a location in a two-dimensional image coordinate system with respect to a mobile robot from an image obtained by photographing a specific space where the artificial landmarks are provided; a landmark identification unit comparing a predicted image value of the artificial landmark, obtained by converting a location coordinates value of the artificial landmark into an image coordinates value corresponding to the location in the two-dimensional image coordinate system with respect to a location coordinates value corresponding to a location in an actual three-dimensional spatial coordinate system of the mobile robot, with an image coordinates value detected by the landmark detection unit to detect the location coordinates value of the artificial landmark; a first location calculation unit calculating a current location coordinates value of the mobile robot using a predetermined location calculation algorithm based on the image coordinates value detected by the landmark detection unit and the location coordinates value detected by the landmark identification unit; a second location calculation unit calculating a current location coordinates value of the mobile robot using a predetermined location calculation algorithm based on odometry information of the mobile robot; and a main control unit updating the current location coordinates value of the mobile robot, using the location coordinates value calculated by the first location calculation unit when the location coordinates value calculated by the first location calculation unit exists, or using the location coordinate value obtained from the second location calculation unit when the location coordinates value calculated by the first location calculation unit does not exist.

### CROSS-REFERENCE TO RELATED PATENT APPLICATION

This application claims the benefit of Korean Patent Application No. 10-2006-70838, filed on Jul. 27, 2006, in the Korean Intellectual Property Office, the disclosure of which is incorporated herein in its entirety by reference.

### BACKGROUND OF THE INVENTION

1. Field of the Invention

The present invention relates to a system and method for calculating a location using a combination of odometry and landmarks, and more particularly, to a system and method for calculating a location using a combination of odometry and landmarks in a real-time manner during movement of a mobile robot.

2. Description of the Related Art

In order to allow a mobile robot to make a routing plan to a destination in an indoor room and perform automatic driving, the mobile robot must recognize its location in an indoor room beforehand. A method of using an odometer of a wheel installed in the robot in order to obtain position information is known in the art. In this method, a relative distance and a relative direction are calculated with respect to a particular position using a revolution velocity, a diameter, and a baseline of the wheel in order to obtain the location information. This method of using odometry to obtain the location information has two significant problems. Firstly, since odometry is basically a relative location calculation method, an initial start location should be set beforehand. Secondly, since odometry uses the revolution velocity of the wheel to measure distance, errors may occur when the wheel skids on a slippery ground surface depending on a ground condition. Although odometry provides relatively accurate location information over a short distance, errors are accumulated as a driving distance increases, and a solution for overcoming this problem has not been sufficiently studied. Thus, the location information cannot be reliably obtained using only odometry if there is no error correction method.

In some cases, artificial landmarks have been used as another means for recognizing the location of the robot. In this method, artificial landmarks discriminated from the background are distributedly provided in an indoor room, and image signals obtained by photographing the artificial landmarks using a camera installed in the robot are processed to recognize the artificial landmarks so that the current location of the robot can be obtained. The location of the robot is calculated by referring to the image coordinates of the recognized landmark and coordinate information that has been previously stored for the corresponding landmark.

In order to calculate the location based on landmarks, a predetermined number of landmarks should come within the field of view of the camera. Generally, since the viewing angle of the camera is limited, an area in which the location can be obtained using the landmarks is limited. For this reason, in order to enable location information to be obtained at any location in the entire indoor room based on landmarks, the landmarks should be distributed close enough together so that a required number of landmarks are in the field of view of the camera at an arbitrary position in an indoor room. It is not easy to arrange the landmarks to satisfy this condition, and in particular, this method is considered to be very inefficient from the viewpoint of cost, time, and aesthetical appearance when a location measurement system is constructed in a wide area space such as a market or a public building using only artificial landmarks. In addition, when the landmark is temporarily obscured by obstacles such as visitors or customers, the location information cannot be appropriately obtained.

Typical artificial landmarks include geometric patterns such as circular and rectangular shapes or barcodes that can be discriminated from the background. In order to calculate the location of the robot, a process of recognizing these kinds of patterns should be performed beforehand. Also, since the image signal input through the camera is influenced by various conditions such as a distance between the landmark and the camera, a direction, and illumination, it is difficult to obtain stable recognition performance in a common indoor environment. In particular, since image signals become weak during the night, it is nearly impossible to perform the process of recognizing patterns based on image processing during the night.

In order to overcome the aforementioned problem in image processing, a method of using a predetermined wavelength band of light beams has been proposed. In this method, a light source capable of irradiating a predetermined wavelength band of light beams, such as an infrared light emitting diode (IR-LED), is used as the artificial landmark, and an optical filter capable of transmitting only the corresponding wavelength band is installed in the camera, so that only signals irradiated from the light sources of landmarks can be captured in the camera image. Accordingly, the image processing procedure for detecting artificial landmarks can be simplified, and recognition reliability can also be improved. However, since these light sources of the landmarks do not have different shapes, the landmarks should be appropriately discriminated from one another. In order to discriminate the light sources of the landmarks, a method of detecting the landmarks by sequentially turning on/off the light sources has been proposed. However, the process of sequentially turning on/off the light sources requires a great amount of time which increases in proportion to the number of landmarks. Also, the location information cannot be provided in a real-time manner as the recognition of the landmarks should be performed in a state in which the robot pauses. Therefore, this method cannot be applied during the movement.

As described above, both the conventional methods using odometry and the artificial landmarks have some shortcomings. Although the method of using odometry provides high accuracy over a short distance, errors may be accumulated as the driving distance increases due to the relative location measurement. Therefore, this method is not considered to be easy. On the other hand, although the method of using the artificial landmarks provides absolute location information supposing the landmarks are successfully detected, the location information may not be obtained when the detection of landmarks fails due to obstacles. Also, if the space to be covered by the location measurement system increases, arranging new landmarks is burdensome.

In addition, the method of using the artificial landmarks is sensitive to external conditions such as illumination and cannot reliably detect landmarks when the landmarks are detected through a pattern recognition process using discriminatable patterns as the artificial landmarks. Even when light sources and an optical filter are adopted in the landmarks and the camera, respectively, in order to solve this problem, it is difficult to discriminate the landmarks from one another even if the landmarks are appropriately detected.

### SUMMARY OF THE INVENTION

The present invention provides a system and method for calculating location information using a combination of an artificial landmark based location calculation method and an odometry based location calculation method, by which successive location information can be calculated using only a little number of landmarks over any wide area indoor room regardless of a landmark detection failure or temporary landmark obscurity.

In addition, the present invention provides a technology of identifying the landmark all day long in a real-time manner using light sources of the landmarks and an optical filter regardless of changes in external conditions such as illumination without controlling an on/off operation of the light source of the landmark.

According to an aspect of the present invention, there is provided a system for calculating a location in a real-time manner using a combination of odometry and artificial landmarks, the system comprising: a landmark detection unit detecting an image coordinates value of the artificial landmark corresponding to a location in a two-dimensional image coordinate system with respect to a mobile robot from an image obtained by photographing a specific space where the artificial landmarks are provided; a landmark identification unit comparing a predicted image value of the artificial landmark, obtained by converting a location coordinates value of the artificial landmark into an image coordinates value corresponding to the location in the two-dimensional image coordinate system with respect to a location coordinates value corresponding to a location in an actual three-dimensional spatial coordinate system of the mobile robot, with an image coordinates value detected by the landmark detection unit to detect the location coordinates value of the artificial landmark; a first location calculation unit calculating a current location coordinates value of the mobile robot using a predetermined location calculation algorithm based on the image coordinates value detected by the landmark detection unit and the location coordinates value detected by the landmark identification unit; a second location calculation unit calculating a current location coordinates value of the mobile robot using a predetermined location calculation algorithm based on odometry information of the mobile robot; and a main control unit updating the current location coordinates value of the mobile robot, using the location coordinates value calculated by the first location calculation unit when the location coordinates value calculated by the first location calculation unit exists, or using the location coordinate value obtained from the second location calculation unit when the location coordinates value calculated by the first location calculation unit does not exist.

The artificial landmark may include a light source, such as an electroluminescent device or a light emitting diode, which has unique identification information and can irradiate a particular wavelength band of light beams.

The landmark detection unit may include a camera having an optical filter capable of transmitting only a specific wavelength band of light beams irradiated by the light source included in the artificial landmark.

The mobile robot may include a landmark control unit generating an ON/OFF signal for selectively turning on/off the light sources of the artificial landmarks, and each of the landmarks may include a light source control unit receiving a signal from the landmark control unit and controlling turning on/off the light sources.

At least two artificial landmarks are provided within an area in which the mobile robot moves.

The main control unit may control a camera included in the mobile robot or an odometer sensor by transmitting signals through wired or wireless communication.

The main control unit may repeat processes of updating a current location coordinates value of the mobile robot, receiving the location coordinates value obtained from the first or second location calculation unit, and updating the current location coordinates value of the mobile robot again.

The landmark detection unit calculates the image coordinate value of the artificial landmark on the basis of the image coordinates values obtained by regarding the mobile robot as a center point of the two-dimensional image coordinate system

The landmark identification unit may calculate a deviation between the predicted image value of the artificial landmark and the image coordinates value detected by the landmark detection unit, and may calculate a location coordinate value of the artificial landmark corresponding to an image coordinates value having the least deviation.

The first location calculation unit may calculate a scaling factor, a factor for a two-dimensional circulation, and a two-dimensional horizontal shifting constant that are required to convert the image coordinate system into the spatial coordinate system using the image coordinates value detected by the landmark detection unit and the location coordinates value detected by the landmark identification unit, and may convert the image coordinates value of the mobile robot corresponding to a center point of the two-dimensional image coordinate system into a location coordinates value of the spatial coordinate system.

The second location calculation unit may measure a movement velocity of the mobile robot using a wheel sensor attached to a wheel of the mobile robot, and calculate a current location coordinates value of the mobile robot on the basis of a moving distance corresponding to the movement velocity.

According to another aspect of the present invention, there is provided a method of calculating a location in a real-time manner using a combination of odometry and artificial landmarks, the method comprising: (a) detecting a image coordinates value of the artificial landmark corresponding to a location in a two-dimensional image coordinate system with respect to a mobile robot from an image obtained by photographing a specific space where the artificial landmarks are provided; (b) comparing a predicted image value of the artificial landmark, obtained by converting a location coordinates value of the artificial landmark into an image coordinates value corresponding to the location in the two-dimensional image coordinate system with respect to a location coordinates value corresponding to a location in an actual three-dimensional spatial coordinate system of the mobile robot, with an image coordinates value detected by the landmark detection unit to detect the location coordinates value of the artificial landmark; (c) calculating a current location coordinates value of the mobile robot using a predetermined location calculation algorithm based on the image coordinates value detected in the (a) detection of the image coordinates value and the location coordinates value detected in the (b) comparison of the predicted image value; (d) calculating a current location coordinates value of the mobile robot using a predetermined location calculation algorithm based on odometry information of the mobile robot; and (e) updating the current location coordinates value of the mobile robot using the location coordinates value calculated in the (c) calculation of the current location coordinates value when the location coordinates value calculated in the (c) calculation of the current location coordinates value exists, or using the location coordinate value obtained in the (d) calculation of the current location coordinates value when the location coordinates value calculated in the (c) does not exist.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating components of a system for calculating a location using a combination of odometry and landmarks in a real-time manner according to an exemplary embodiment of the present invention;

FIG. 2 is a schematic diagram for describing a process of photographing landmarks performed by a mobile robot according to an exemplary embodiment of the present invention;

FIG. 3A is a photograph taken by a typical camera installed in a mobile robot;

FIG. 3B is a photograph taken by a camera installed in a mobile robot using an optical filter according to an exemplary embodiment of the present invention;

FIG. 4 is a flowchart illustrating a process of calculating a location using a combination of odometry and artificial landmarks in a real-time manner according to an exemplary embodiment of the present invention; and

FIG. 5 is a graph for describing a relationship for transformation between a spatial coordinate system and an image coordinate system according to an exemplary embodiment of the present invention.

### DETAILED DESCRIPTION OF THE INVENTION

Hereinafter, exemplary embodiments of the present invention will be described in detail with reference to the accompanying drawings.

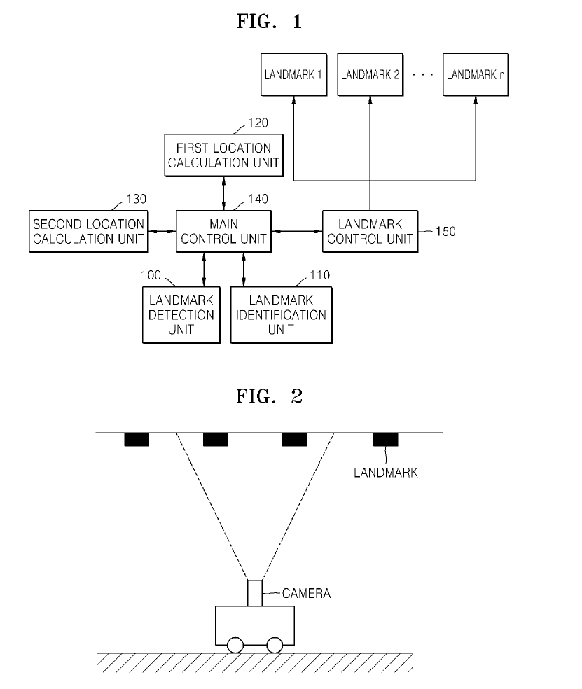

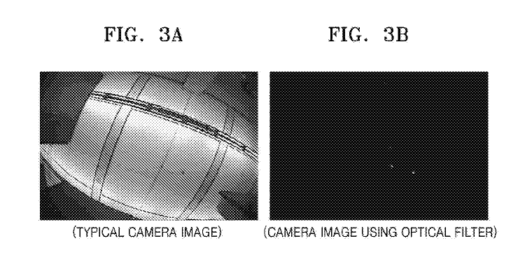

FIG. 1 is a block diagram illustrating components of a system for calculating a location of a mobile robot in a real-time manner according to an exemplary embodiment of the present invention. FIG. 2 is a schematic diagram for describing a process of photographing landmarks performed by a mobile robot according to an exemplary embodiment of the present invention. FIG. 3A is a photograph taken by a typical camera installed in a mobile robot, and FIG. 3B is a photograph taken by a camera installed in a mobile robot using an optical filter according to an exemplary embodiment of the present invention;

FIG. 2 shows a process of obtaining images in a landmark detection unit 100 of FIG. 1, and FIGS. 3A and 3B show images obtained through the process of FIG. 2. They will be described in association with FIG. 1.

Referring to FIG. 1, the system according to an exemplary embodiment of the present invention includes a landmark detection unit 100, a landmark identification unit 110, a first location calculation unit 120, a second location calculation unit 130, a main control unit 140, and a landmark control unit 150.

The landmark control unit 150 controls on/off operations of light sources of landmarks. Each light source has a light emitting diode (LED) or an electroluminescent element, capable of emitting light beams having a specific wavelength and brightness of, which can be turned on and off according to a signal through an external communication control module. In addition, each landmark has a unique identification (ID) to discriminate it from other landmarks, and is usually attached to a ceiling in a work space. The location at which the landmark is attached in the work space (i.e., spatial coordinates) is stored through an actual measurement.

The landmark detection unit 100 detects image coordinates of the landmarks from an image signal input through the camera. Preferably, the camera has an optical filter for transmitting only a predetermined wavelength of light beams irradiated from the light source of the corresponding landmark. In addition, as shown in FIG. 2, the camera is installed in a mobile robot in such a way that a lens of the camera views the ceiling, and an optical axis of the camera is perpendicular to the ground surface. Since the optical filter installed in the camera is designed to transmit only light beams having the same wavelength as that of the light source of the landmark, an image shown in FIG. 3B is obtained. As a result, it is possible to simplify an image processing procedure for detecting landmarks and allow the landmarks to be detected all day long regardless of changes in external conditions such as illumination.

The landmark identification unit 110 identifies the detected landmarks. Since the optical filter for transmitting only light beams having the same wavelength band as that of the light sources of the landmarks is used in the image processing procedure for detecting the landmarks, the image processing procedure for detecting the landmarks is simply performed by detecting regions having a brightness equal to or higher than a predetermined critical value through a binarization process performed on the image signals. The image coordinates of the landmark obtained by detecting the light source are determined as the coordinates of the center point of the detected region through binarization.

The first location calculation unit 120 calculates spatial coordinates and a direction of the robot on the basis of the detected image coordinates of the landmark and the spatial coordinates previously stored for the corresponding landmark in a work space.

When it is determined that the number of detected landmarks is sufficient to calculate the location of the robot through the landmark detection process, the location of the robot is calculated on the basis of the image coordinates of the detected landmarks and the previously stored spatial coordinates of the corresponding landmark. In order to refer to the spatial coordinates of the landmarks, the detected landmarks should be identified beforehand. The following description relates to only a location calculation process performed when the detected landmark is identified. A more detailed description of the location calculation process will be given below in association with FIG. 3.

In order to calculate the location of the robot, at least two landmarks should be detected. At least three landmarks may be used to minimize errors in the location calculation. Assume that, for two detected landmarks Lᵢ, and Lⱼ, the detected image coordinates are (xᵢ, yᵢ) and (xⱼ, yⱼ), and the previously stored spatial coordinates are (Xᵢ, Yᵢ, Zᵢ), (Xⱼ, Yⱼ, Zⱼ), respectively. In this case, the Z-axis coordinates denote the vertical distance between the camera and the landmarks, and are necessary to obtain accurate location information despite variations in the height of the ceiling over an indoor room where the robot is driven. In other words, the method according to the present invention may not require separate ceiling height information (i.e., Z-axis coordinates) if the height of the ceiling is constant.

First of all, image coordinates (pᵢ, qᵢ) and (pⱼ, qⱼ) obtained by correcting distortion of a camera lens from the original image coordinates are calculated as follows:

$$[ \begin{matrix}{x}_{d} \\ {y}_{d} \\ 1\end{matrix} ] = {[ \begin{matrix}{f}_{x} & 0 & {c}_{x} \\ 0 & {f}_{y} & {c}_{y} \\ 0 & 0 & 1\end{matrix} ]}^{- 1} [ \begin{matrix}x \\ y \\ 1\end{matrix} ] ⇒ \{ \begin{matrix}{x}_{d} = [ x - {c}_{x} ] / {f}_{x} \\ {y}_{d} = [ y - {c}_{y} ] / {f}_{y}\end{matrix} \\ [ \begin{matrix}{x}_{u} \\ {y}_{u}\end{matrix} ] = \frac{1}{1 + {k}_{1} {r}^{2} + {k}_{2} {r}^{4} + {k}_{3} {r}^{6}} [ \begin{matrix}{x}_{d} \\ {y}_{d}\end{matrix} ] , {r}^{2} = {x}_{u}^{2} + {y}_{u}^{2} \\ [ \begin{matrix}p \\ q \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{x}_{u} \\ {y}_{u} \\ 1\end{matrix} ]$$

where, fₓ and f_{y} denote focal distances; cₓ and c_{y} denote internal camera parameters indicating image coordinates of the center point of the lens; k₁, k₂, and k₃ denote lens distortion coefficients corresponding to variables obtained through a camera calibration process. In this equation, the detected image coordinates value is designated as (x, y), and the coordinates value obtained by correcting the distortion of the lens is designated as (p, q) without indexing any subscript for discriminating the two landmarks.

The camera lens distortion correction is necessary to calculate accurate locations. Particularly, this process is indispensable in a case where a fisheye lens is used to enlarge the field of view of the camera. Since lens distortion correction is performed only for the image coordinates of the detected landmarks, additional processing time is not needed.

Subsequently, a height normalization process is performed in order to remove image coordinates variations caused by the height difference of the ceiling to which the landmarks are attached. As described above, this process may be omitted when the height of the ceiling is constant over the entire indoor room. The image coordinates of the landmark attached to the ceiling are in inverse proportion to the height of the ceiling, so that the image coordinates of the landmark in a farther the point of origin as the height of the ceiling increases, while the image coordinates of the landmark in a nearer the point of origin as the height of the ceiling is reduced. Therefore, the image coordinates (uᵢ, vᵢ) and (uⱼ, vⱼ) normalized to a reference height h from the distortion-corrected image coordinates (pᵢ, qᵢ) and (pⱼ, qⱼ) can be obtained as follows:

$$( {u}_{i} , {v}_{i} ) = \frac{{Z}_{i}}{h} ( {p}_{i} , {q}_{i} )$$

$$( {u}_{j} , {v}_{j} ) = \frac{{Z}_{j}}{h} ( {p}_{j} , {q}_{j} ) ,$$

where, h denotes an arbitrary positive constant.

Subsequently, location information (rₓ, r_{y}, θ) of the robot is calculated using the image coordinates (uᵢ, vᵢ) and (uⱼ, vⱼ) obtained by performing the distortion correction and the height normalization for the detected landmarks and the stored spatial coordinates (Xᵢ, Yᵢ, Zᵢ) and (Xⱼ, Yⱼ, Zⱼ), where θ denotes a heading angle of the robot with respect to the Y-axis of the spatial coordinate system.

Since the camera views the ceiling at a perpendicular angle, it is assumed that the robot is located in the center of the image. In other words, the image coordinates of the robot become (cₓ, c_{y}). The spatial coordinates (rₓ, r_{y}) of the robot can be obtained by transforming the image coordinates of the landmarks L₁, L₂ into spatial coordinates and applying them to the image coordinates (cₓ, c_{y}). Since the camera views the ceiling at a perpendicular angle, the coordinate system transformation may be performed through scale transformation, two-dimensional circulation, and two-dimensional horizontal shifting as follows:

$$s = \frac{D}{d} = \frac{\sqrt{{( {X}_{i} - {X}_{j} )}^{2} + {( {Y}_{i} - {Y}_{j} )}^{2}}}{\sqrt{{( {u}_{i} - {u}_{j} )}^{2} + {( {v}_{i} - {v}_{j} )}^{2}}}$$

$$cos θ = \frac{( {u}_{j} - {u}_{i} ) ( {X}_{j} - {X}_{i} ) + ( {v}_{j} - {v}_{i} ) ( {Y}_{j} - {Y}_{i} )}{dD}$$

$$sin θ = \frac{( {u}_{j} - {u}_{i} ) ( {Y}_{j} - {Y}_{i} ) - ( {v}_{j} - {v}_{i} ) ( {X}_{j} - {X}_{i} )}{dD} \\ [ \begin{matrix}{r}_{x} \\ {r}_{y}\end{matrix} ] = s [ \begin{matrix}cos θ & - sin θ \\ sin θ & cos θ\end{matrix} ] ( [ \begin{matrix}{c}_{x} \\ {c}_{y}\end{matrix} ] - [ \begin{matrix}{u}_{i} \\ {v}_{i}\end{matrix} ] ) + [ \begin{matrix}{X}_{i} \\ {Y}_{i}\end{matrix} ] ,$$

where, the scaling factor s is constant regardless of a pair of the landmarks used in the location calculation, and the value obtained by performing initial location calculation is stored in a memory unit in order to predict image coordinates for a subsequent landmark identification process.

In the above method, the location of the robot is calculated on the basis of the image coordinates obtained from the image and the previously stored spatial coordinates of the landmarks. If this method is reversely applied, the image coordinates can be obtained from the camera image on the basis of the location of the robot and the spatial coordinate of the corresponding landmark.

Assume that the current location of the robot is (rₓ, r_{y}, θ), and the spatial coordinates of the landmark Lₖ are (Xₖ, Yₖ, Zₖ), where k=1, and n denotes the total number of attached landmarks. Then, predicted image coordinates (ûₖ, \hat{v}ₖ) of the landmark Lₖ without considering the lens distortion and the height normalization can be calculated as follows:

$$[ \begin{matrix}{\hat{u}}_{k} \\ {\hat{v}}_{k}\end{matrix} ] = [ \begin{matrix}{c}_{x} \\ {c}_{y}\end{matrix} ] - \frac{1}{s} [ \begin{matrix}cos θ & sin θ \\ - sin θ & cos θ\end{matrix} ] ( [ \begin{matrix}{r}_{x} \\ {r}_{y}\end{matrix} ] - [ \begin{matrix}{X}_{k} \\ {Y}_{k}\end{matrix} ] ) , k = 1 , … , n .$$

If the height of the landmark and the lens distortion are reflected on the calculated image coordinates (ûₖ, \hat{v}ₖ), finally predicted image coordinates (\hat{x}ₖ, ŷₖ) can be obtained as follows:

$$[ \begin{matrix}{\hat{p}}_{k} \\ {\hat{q}}_{k} \\ 1\end{matrix} ] = \frac{h}{{Z}_{k}} [ \begin{matrix}{\hat{u}}_{k} \\ {\hat{v}}_{k} \\ 1\end{matrix} ] \\ [ \begin{matrix}{\hat{x}}_{u \_ k} \\ {\hat{y}}_{u \_ k} \\ 1\end{matrix} ] = {[ \begin{matrix}{f}_{x} & 0 & {c}_{x} \\ 0 & {f}_{y} & {c}_{y} \\ 0 & 0 & 1\end{matrix} ]}^{- 1} [ \begin{matrix}{\hat{p}}_{k} \\ {\hat{q}}_{k} \\ 1\end{matrix} ] \\ [ \begin{matrix}{\hat{x}}_{d \_ k} \\ {\hat{y}}_{d \_ k}\end{matrix} ] = ( 1 + {k}_{1} {r}^{2} + {k}_{2} {r}^{4} + {k}_{3} {r}^{6} ) [ \begin{matrix}{\hat{x}}_{u \_ k} \\ {\hat{y}}_{u \_ k}\end{matrix} ] , {r}^{2} = {\hat{x}}_{u \_ k}^{2} + {\hat{y}}_{u \_ k}^{2} \\ [ \begin{matrix}{\hat{x}}_{k} \\ {\hat{y}}_{k} \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{\hat{x}}_{d \_ k} \\ {\hat{y}}_{d \_ k} \\ 1\end{matrix} ] .$$

The second location calculation unit 130 calculates location information on the basis of the odometry. Preferably, the mobile robot has a sensor for obtaining odometry information, such as an encoder.

The location information using odometry is calculated on the basis of the movement velocities of both wheels of the robot. The movement velocities of the wheels are measured using wheel sensors attached to each wheel. Assuming that the location of the robot at a time point (t−1) is (rₓ^{t-1}, r_{y}^{t-1}, θ^{t-1}) the movement velocities of both wheels at a time point t are vₗ and vᵣ, the wheel baseline is w, and the interval between the time points t and t−1 is Δt, the location of the robot (rₓ^{t}, r_{y}^{t}, θ^{t}) at the time point t can be calculated as follows:

$${r}_{x}^{t} = {r}_{x}^{t - 1} + Δ T cos ( {θ}^{t - 1} + \frac{Δ R}{2} )$$

$${r}_{y}^{t} = {r}_{y}^{t - 1} + Δ T sin ( {θ}^{t - 1} + \frac{Δ R}{2} )$$

$${θ}^{t} = {θ}^{t - 1} + Δ R , \\ where , \\ Δ T = \frac{{v}_{l} + {v}_{r}}{2} Δ t$$

$$Δ R = \frac{{v}_{r} - {v}_{l}}{W} Δ t .$$

The location information calculated at the time point t is used to calculate the location information at the time point t+1. Location information at the time point when the landmark based location calculation fails is used as initial location information.

The main control unit 140 stores the spatial coordinates of the landmark in a work space and a camera lens distortion coefficient and entirely controls each module, so that successive location information is calculated while switching between a landmark mode and an odometry mode is automatically performed.

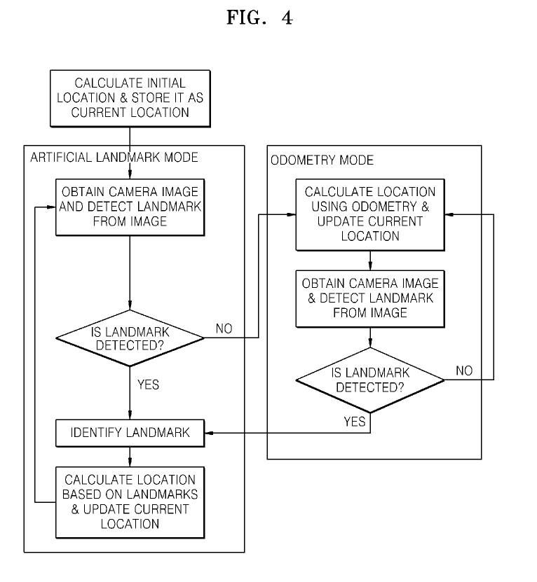

FIG. 4 is a flowchart for describing a process of calculating a location of a mobile robot in a real-time manner according to an exemplary embodiment of the present invention.

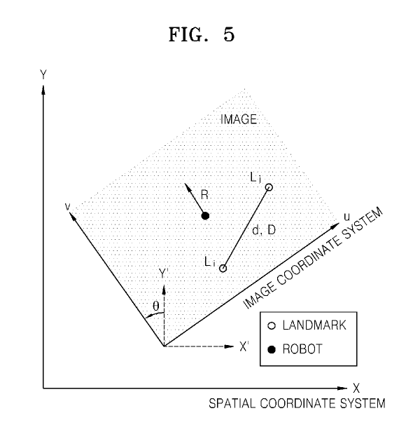

FIG. 5 is a graph for describing a relationship of transformation between a spatial coordinate system and an image coordinate system according to an exemplary embodiment of the present invention.

FIG. 5 simultaneously shows the spatial coordinate system and the image coordinate system used for transformation between the image coordinates and the spatial coordinates in the process of calculating the location of the robot in a real-time manner, which will be described in more detail in association with FIG. 4.

First of all, initial location information of the mobile robot is calculated while the on/off operations of artificial landmarks are controlled. The initial location calculation is performed at the place where the landmark is provided. After the initial location is calculated, the location information is updated in a real-time manner through a landmark based location calculation process as long as any landmark is continuously detected within the field of view of the camera (i.e., in an artificial landmark mode). When the detection of the landmark fails, for example, when a landmark disappears out of the field of view of the camera as the robot moves, or when the landmark is temporarily obscured by obstacles, the location calculation process is switched to an odometry mode, and then, subsequent location information is calculated using odometry (in an odometry mode). In the odometry mode, it is determined whether or not a landmark is detected in the camera image in every location update period. When a landmark is not detected, the location information is continuously calculated in an odometry mode. Otherwise, when a landmark is detected, the location information is calculated in an artificial landmark mode.

The initial location recognition is done to recognize the location of the robot in an indoor room when the robot does not initially have any location information at all. Since there is no information on the location of the robot when the initial location is calculated, it is impossible to identify the detected landmark through only image processing. Therefore, the landmark is identified in the initial location calculation process using a conventional control method (i.e., by sequentially turning on/off the light sources of the landmarks). Specifically, only one of a plurality of light sources provided in an indoor room is turned on while other light sources are turned off. The light source turn-on command may be issued by transmitting a turn-on signal to the corresponding light source through a landmark control module. Then, the image is obtained using the camera, and the light source is detected in the image, so that the detected light source is identified as the landmark transmitting the turn-on signal through the landmark control module. Subsequently, the next landmark is selected, and the turn-on signal is transmitted, so that the landmark detection process is repeated until the number of detected landmarks is sufficient to calculate the location of the robot.

When the number of detected landmarks is sufficient to calculate the location, and they are identified through the above process, the initial location information of the robot is calculated by applying the aforementioned landmark based location calculation method. It should be noted that the initial location recognition should be performed in the place where the landmarks are provided.

Although this initial location recognition process takes time as the process of obtaining the image and detecting the landmarks should be performed while the light sources of the landmarks are sequentially turned on and off in a state in which the robot pauses its movement, the overall driving of the robot is not influenced because this process is performed only once when the robot is initialized.

Alternatively, the robot may be controlled to always start to drive at a specific location, and this specific location may be set as an initial location. For example, considering that an electrical charger system is necessary to operate the robot, the location of the electrical charger system may be set as the initial location.

In a landmark based location update operation, an image is obtained from the camera at a predetermined time interval, the landmarks are detected in the obtained image, and the location information of the robot is updated (in an artificial landmark mode). The photographing speed may be determined depending on the camera. For example, when a typical camera that can obtain 30 image frames per second is used, the location update period of the robot can be set to 30 Hz. This process is continuously performed as long as the landmark is detected within the field of view of the camera.

Now, how to update the location information of the robot on the basis of the artificial landmarks during the driving will be described. First of all, it is assumed that the number of landmarks detected in the camera image is sufficient to calculate the location of the robot within the current location update period (at a time point t). In order to identify the detected landmarks, the image coordinates of every landmark provided in an indoor room are predicted on the basis of the location of the robot in the most previous time point (e.g., t−1). The aforementioned method of predicting the image coordinates may be used in this case. Since the predicted image coordinates are not calculated on the basis of the current location but the most previous location of the robot, the predicted image coordinates may be deviated from the current image coordinates if the robot moves for the time interval between the time points t−1 and t. However, since the driving speed of the robot is limited, and the photographing speed of the camera is sufficiently fast, the deviation is not very large.

For example, assuming that the photographing speed of the camera is set to 30 frames per second, and a movement velocity of the robot is set to 3 m/s, the robot physically moves 10 cm for the shot-to-shot interval of the camera. Therefore, only several pixels in an image are changed, considering the height of a typical ceiling. As a result, the detected landmark can be identified in such a way that the image coordinates of the landmark detected to be closest to the most previous location of the corresponding landmark in the current image can be predicted as the image coordinates of the current location of the landmark.

Alternatively, the landmarks detected in the camera image in the current location update period can be identified as follows.

The neariest landmark with the robot out of landmark detected in the update period just before preseut location becomes an equal landmark and it pursues,

When the most previously detected landmark is disappeared from the field of view of the camera, and a new landmark is detected within the field of view of the camera as the robot moves, the new landmark can be identified using the aforementioned image coordinates prediction method.

When the detected landmark is identified as described above, the location information of the robot is calculated using the aforementioned landmark based location calculation method by referring to the spatial coordinates previously stored for the corresponding landmark, and then the current location information is updated using this coordinate information. The updated location information is used to predict the image coordinates in the subsequent process of the location information update period. This process is repeated as long as landmarks are detected, so as to provide the location information in a real-time manner.

If the landmark detection fails when the landmark disappears from the field of view of the camera or is obscured by any obstacle as the robot moves, the calculation mode is changed to the odometry mode, and the subsequent location information is calculated using odometry.

In the odometry mode, the camera image is obtained in every location information update period to inspect whether or not the landmark is detected while the location information is updated using the aforementioned odometry information. When the landmark is detected within the field of view of the camera, the calculation mode automatically returns to the artificial landmark mode using the following method.

When the landmark is detected within the camera image while the location information of the robot is calculated in the odometry mode, the image coordinates of each landmark are predicted on the basis of the robot location information calculated using odometry. The prediction of the image coordinates is performed using the aforementioned landmark image coordinates prediction method. The detected landmark is identified in a similar way to the landmark based location update method, in which the image coordinates closest to the image coordinates of the detected landmark are predicted as the current image coordinates of the landmark. If the landmark is identified, the location is calculated using the landmark based location calculation method, and the current location is updated. Subsequent location information is calculated in the artificial landmark mode.

When the image coordinates are predicted on the basis of the location information obtained in the odometry mode, a deviation between the predicted image coordinates of the landmark and the actual image coordinates occurs due to errors in the odometer. However, since odometry provides relatively accurate location information over a short distance, it is possible to successfully identify the landmark as long as the driving distance is not too long.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention, a location measurement system capable of covering a wide area can be constructed with only a little number of landmarks using odometry. Therefore, it is possible to reduce cost and time for constructing the location measurement system. Also, it is possible to provide a safe location measurement system capable of providing location information even when a landmark based location calculation fails.

In addition, according to the present invention, the robot is not required to stop to recognize its location, and it is possible to successively provide real-time location information over any wide indoor area by attaching only a little number of landmarks regardless of obscurity or failure in detecting the landmarks. Therefore, it is possible to allow the mobile robot to safely recognize its location at any place in an indoor room, accordingly make a routing plan to a desired destination, and freely drive.

Furthermore, according to the present invention, it is possible to construct a location measurement system capable of providing location information regardless of a size or a structure of an indoor environment such as the height of the ceiling. Therefore, it is possible to use the mobile robot in a variety of indoor environments and widen a range of robot service applicability.

Still furthermore, according to the present invention, since the location information can be successively calculated in a real-time manner regardless of a driving condition of the robot, it is possible to dynamically change the routing plan on the basis of the calculated location information. Therefore, it is possible to smoothly control motion of the robot, dynamically avoid obstacles, and change a destination during the driving.

Still furthermore, according to the present invention, the robot is not required to stop its movement or delay separate time to recognize its location. Therefore, it is possible to improve work efficiency in a work space.

Still furthermore, according to the present invention, it is possible to provide the location information all day long regardless of changes in the external environment such as illumination. Therefore, it is possible to safely drive the robot, and particularly, a robot patrol service can be provided in the night.

Still furthermore, in the method of identifying the landmark using the image coordinates prediction according to the present invention, it is possible to verify whether or not the recognition is appropriately performed by comparing the image coordinates of the landmark recognized in the image processing with the predicted image coordinates even when geometrical or natural landmarks are used instead of light sources. Therefore, it is possible to improve the reliability of a typical landmark based location calculation system.

The location calculation system according to the present invention can be applied to other devices or appliances that have been manually carried as well as a mobile robot.

According to the present invention, absolute coordinates in an indoor room are provided in a real-time manner. Therefore, it is possible to more accurately draw an environmental map by reflecting the data measured on the basis of absolute location information provided according to the present invention when an environmental map for the indoor environment is created using ultrasonic, infrared, or vision sensors.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A system for calculating a location in a real-time manner using a combination of odometry and artificial landmarks, the system comprising:
a landmark detection unit detecting an image coordinates value of an artificial landmark corresponding to a location in a two-dimensional image coordinate system with respect to a mobile robot from an image obtained by photographing a specific space where the artificial landmarks are provided;
a landmark identification unit comparing a predicted image value of the artificial landmark, obtained by converting a location coordinates value of the artificial landmark into an image coordinates value corresponding to the location in the two-dimensional image coordinate system with respect to a location coordinates value corresponding to a location in an actual three-dimensional spatial coordinate system of the mobile robot, with an image coordinates value detected by the landmark detection unit to detect the location coordinates value of the artificial landmark;
a first location calculation unit calculating a current location coordinates value of the mobile robot using a predetermined location calculation algorithm based on the image coordinates value detected by the landmark detection unit and the location coordinates value detected by the landmark identification unit;
a second location calculation unit calculating a current location coordinates value of the mobile robot using a predetermined location calculation algorithm based on odometry information of the mobile robot; and
a main control unit updating the current location coordinates value of the mobile robot, using the location coordinates value calculated by the first location calculation unit when the location coordinates value calculated by the first location calculation unit exists, or using the location coordinate value obtained from the second location calculation unit when the location coordinates value calculated by the first location calculation unit does not exist.

2. The system of claim 1, wherein the artificial landmark includes a light source, such as an electroluminescent device or a light emitting diode, which has unique identification information and can irradiate a particular wavelength band of light beams.

3. The system of claim 2, wherein the landmark detection unit includes a camera having an optical filter capable of transmitting only a specific wavelength band of light beams irradiated by the light source included in the artificial landmark.

4. The system of claim 2, wherein the mobile robot includes a landmark control unit generating an ON/OFF signal for selectively turning on/off the light sources of the artificial landmarks, and each of the landmarks includes a light source control unit receiving a signal from the landmark control unit and controlling turning on/off the light sources.

5. The system of claim 1, wherein at least two artificial landmarks are provided within an area in which the mobile robot moves.

6. The system of claim 1, wherein the main control unit controls a camera included in the mobile robot or an odometer sensor by transmitting signals through wired or wireless communication.

7. The system of claim 1, wherein the main control unit repeats processes of updating a current location coordinates value of the mobile robot, receiving the location coordinates value obtained from the first or second location calculation unit, and updating the current location coordinates value of the mobile robot again.

8. The system of claim 1, wherein the landmark detection unit calculates the image coordinate value of the artificial landmark on the basis of the image coordinate values obtained by regarding the mobile robot as a center point of the two-dimensional image coordinate system.

9. The system of claim 1, wherein the landmark identification unit calculates a deviation between the predicted image value of the artificial landmark and the image coordinates value detected by the landmark detection unit, and calculates a location coordinate value of the artificial landmark corresponding to an image coordinates value having the least deviation.

10. The system of claim 1, wherein the first location calculation unit calculates a scaling factor, a factor for a two-dimensional circulation, and a two-dimensional horizontal shifting constant that are required to convert the image coordinate system into the spatial coordinate system using the image coordinates value detected by the landmark detection unit and the location coordinates value detected by the landmark identification unit, and the first location calculation unit converts the image coordinate value of the mobile robot corresponding to a center point of the two-dimensional image coordinate system into a location coordinates value of the spatial coordinate system.

11. The system of claim 1, wherein the second location calculation unit measures a movement velocity of the mobile robot using a wheel sensor attached to a wheel of the mobile robot, and calculates a current location coordinates value of the mobile robot on the basis of a moving distance corresponding to the movement velocity.

12. A method of calculating a location in a real-time manner using a combination of odometry and artificial landmarks, the method comprising:
(a) detecting an image coordinates value of the artificial landmark corresponding to a location in a two-dimensional image coordinate system with respect to a mobile robot from an image obtained by photographing a specific space where the artificial landmarks are provided;
(b) comparing a predicted image value of the artificial landmark, obtained by converting a location coordinates value of the artificial landmark into an image coordinates value corresponding to the location in the two-dimensional image coordinate system with respect to a location coordinates value corresponding to a location in an actual three-dimensional spatial coordinate system of the mobile robot, with an image coordinates value detected by the landmark detection unit to detect the location coordinates value of the artificial landmark;
(c) calculating a current location coordinates value of the mobile robot using a predetermined location calculation algorithm based on the image coordinates value detected in the (a) detection of the image coordinates value and the location coordinates value detected in the (b) comparison of the predicted image value;
(d) calculating a current location coordinates value of the mobile robot using a predetermined location calculation algorithm based on odometry information of the mobile robot; and
(e) updating the current location coordinates value of the mobile robot using the location coordinates value calculated in the (c) calculation of the current location coordinates value when the location coordinates value calculated in the (c) calculation of the current location coordinates value exists, or using the location coordinate value obtained in the (d) calculation of the current location coordinates value when the location coordinates value calculated in the (c) does not exist.

13. The method of claim 12, wherein the (e) updating the current location coordinates value is repeated by performing processes of calculating the location coordinates value through the (c) calculation of the current location coordinates value based on the image coordinates value or (d) calculation of the current location coordinates value based on the odometry information after the current location coordinate value of the mobile robot is updated, and updating the current location coordinate value of the mobile robot using the calculated location coordinates value.

14. A computer-readable medium having embodied thereon a computer program for performing the method of claim 12.

15. A computer-readable medium having embodied thereon a computer program for performing the method of claim 13.
